(19) United States
(12) Patent Application Publication
(10) Pub. No.: US 2024/0297510 A1
(43) Pub. Date: Sep. 5, 2024

(54) SEMICONDUCTOR-BASED FUSE FOR THE SAFE DISCONNECTING OF A CHARGING-CURRENT PATH

(71) Applicant: Lisa Dräxlmaier GmbH, Vilsbiburg (DE)

(72) Inventors: Stefan HAGENAUER, Essenbach (DE); Stefan HOFINGER, Sankt Wolfgang (DE); Reinhold HAMMERL, Garching (DE); Michael PFEIFFER, München (DE)

(73) Assignee: Lisa Dräxlmaier GmbH, Vilsbiburg (DE)

(21) Appl. No.: 18/589,870

(22) Filed: Feb. 28, 2024

(30) Foreign Application Priority Data
Mar. 1, 2023 (DE) 102023105117.2

(51) Int. Cl. H02J 7/00; B60L 53/302; B60L 53/62

(52) U.S. Cl. CPC H02J 7/00304; B60L 53/302; B60L 53/62

(57) ABSTRACT

A semiconductor-based fuse for the disconnecting of a charging-current path for the charging of a battery of a vehicle-side high voltage electrical system of a battery-electric vehicle includes one or more semiconductor-switch elements that are switchable in a charging-current path of the battery-electric vehicle, to enable a charging of the battery via the charging-current path. The semiconductor-based fuse includes a measurement sensor system that is connectable in the charging-current path of the battery-electric vehicle, and is to detect a current flowing through the one or more semiconductor-switch elements. The semiconductor-based fuse includes a control system, which is to switch off the one or more semiconductor-switch elements upon the reaching of a threshold value of the detected current, in order to disconnect the vehicle-side high voltage electrical system from the charging-current path.

### CROSS-REFERENCE TO RELATED APPLICATIONS

This application claims priority to and the benefit of DE 10 2023 105 117.2 filed on Mar. 1, 2023. The disclosure of the above application is incorporated herein by reference.

### FIELD

The present disclosure relates to the field of electrical and electronic fuses for the switching-off of overcurrents in battery-electric vehicles. In particular, the present disclosure relates to a semiconductor-based fuse for the disconnecting of a charging-current path for the charging of a battery of a battery-electric vehicle.

### BACKGROUND

The statements in this section merely provide background information related to the present disclosure and may not constitute prior art.

With the charging of battery-electric vehicles (BEVs), faults may occur in the charging infrastructure (charging column and cable). Due to such faults, overcurrents may result in both current-flow directions in the vehicle-side HV (high voltage) electrical system, or in the battery and the fusebox of the BEV.

It has been shown that with conventional charging-path fuses issues can arise with the charging process. In some instances faults arise in the charging process, which may lead to defective batteries and impact charging columns due to short-circuited semiconductors. The faults are usually ascribed to a short-circuit situation of the BEV battery via the charging column.

### SUMMARY

This section provides a general summary of the disclosure and is not a comprehensive disclosure of its full scope or all of its features.

The present disclosure provides a concept for a charging of battery-electric vehicles.

In one example, the present disclosure provides a suitable fuse for the charging-current path of battery-electric vehicles that provides a rapid disconnecting of the battery from the charging-current path in certain situations.

The present disclosure is based on the idea of providing a semiconductor-based fuse for the DC charging-current path, also referred to in the following as a digital fuse (“dFuse”), which recognizes overcurrents such as, for example, short-circuit currents, and disconnects them faster than circuit breakers, melting fuses, or pyrofuses. Here the dFuse can independently reduce the energy stored in the line inductances.

Unlike classical circuit breakers, melting fuses, or pyrofuses, the dFuse functions with semiconductors, which can switch significantly more quickly. Aging or initial damage of the other protective elements in the BEV can thereby be inhibited. In addition, unlike with conventional fuses, all HV components involved in the charging process are protected from overcurrent, since the higher triggering speed of the semiconductor compared to previous fuses can inhibit damage. In addition, the dFuse is digitally resettable, so that the maintenance plan can be omitted or simplified.

With the semiconductor-based fuse or the dFuse presented here, the user is more independent from the safety functions of the charging infrastructure. Faults in the charging infrastructure that could lead to a short circuit of the BEV battery can no longer cause damage to the components of the BEV.

The dFuse switches more rapidly, and can thereby provide protective functions that none of the previously available components could make possible, in order to reduce the stored energy from the circuit inductances. The dFuse, with its semiconductor form, is digitally resettable, and thus significantly simplifies the maintenance plan in comparison to disposable fuses such as melting fuses and pyrofuses.

According to a first aspect, the present disclosure provides a semiconductor-based fuse for the disconnecting of a charging-current path for the charging of a battery of a vehicle-side high voltage electrical system of a battery-electric vehicle, in which the semiconductor-based fuse comprises the following: one or more semiconductor-switch elements, which are switchable in a charging path of the battery-electric vehicle in order to enable a charging of the battery via the charging-current path; a measurement sensor system, which is connectable in the charging-current path of the battery-electric vehicle and is configured to detect a current flowing through the one or more semiconductor switch elements; and a control system that is configured to switch off the one or more semiconductor switch elements upon the reaching of a predetermined or threshold value of the detected current, in order to disconnect the vehicle-side high-voltage electrical system from the charging-current path.

Due to the rapid reaction of the semiconductor switch elements, such a semiconductor-based fuse provides for charging of battery-electric vehicles, so that the faults in the charging process, impacted charging columns or charging infrastructure, short-circuited semiconductors, smoking charging pistols, and triggered melting fuses/pyrofuses are reduced. Due to the rapid reaction of the semiconductor switch elements in certain situations, the semiconductor-based fuse provides a rapid disconnecting of the battery and other components of the vehicle from the charging-current path.

According to one form of the semiconductor-based fuse, the measurement sensor system includes a measurement sensor connected in series with the one or more semiconductor switch elements; and/or the measurement sensor system is configured to determine a current flowing over a switched-on resistance of the one or more semiconductor switch elements.

This results in that the measurement sensor system can determine various types of the current flowing through the semiconductor-switch elements.

According to one form of the semiconductor-based fuse, the measurement sensor system is configured to determine a current in the charging direction that flows from a charging infrastructure to the vehicle-side high voltage electrical system of the battery-electric vehicle, and is further configured to detect a current against the charging direction, which current flows from the vehicle-side high voltage electrical system to the charging infrastructure.

This results in that an excessive charging current from the charging column to the battery can be detected, for example, due to an erroneous or incorrect setting at the charging station, and a short-circuit situation can also be detected, in which a short-circuit current flows from the battery to the charging station, for example, due to a short circuit of the charging station.

According to one form of the semiconductor-based fuse, the control system is configured to switch off the one or more semiconductor switch elements upon detecting of a current in the charging-current path that flows opposite to the charging direction and reaches the threshold value.

This results in that in this manner a short-circuit current can be efficiently recognized that flows against the charging direction, and the fuse can trigger a rapid disconnecting of the battery from the charging-current path.

According to one form of the semiconductor-based fuse, the control system is configured to switch off the one or more semiconductor switch elements unidirectionally, upon detecting a current against the charging direction exceeding the threshold value, or bidirectionally, upon detecting a current in or against the charging direction exceeding the threshold value.

This results in that the fuse can work both unidirectionally and bidirectionally, and thus can recognize and quickly react to the widest variety of situations of overcurrents.

According to one exemplary form of the semiconductor-based fuse, the one or more semiconductor-switch elements include one or more pairs of semiconductor switches connected in parallel, in which each pair includes two semiconductor switches interconnected against each other in series. Alternatively, the one or more semiconductor-switch elements can be interconnected with one another unidirectionally without the semiconductor switches being arranged in pairs.

This results in that the semiconductor pairs connected in parallel in the charging-current path have a higher current-carrying capacity than a single semiconductor switch, with the result that even with very high currents the fuse can provide a rapid switching-off. The semiconductor switches interconnected against one another in series effect both current-flow directions. A unidirectional interconnecting of the semiconductor switches also allows a higher current-carrying capacity.

According to one exemplary form of the semiconductor-based fuse, the measurement sensor system is configured to detect the current flowing through the one or more semiconductor switch elements based on at least one or a combination of the following measurements: a measurement of a switched-on resistance of the one or more semiconductor switch elements; a measurement of a temperature of the one or more semiconductor switch elements; a measurement of a forward voltage of the one or more semiconductor switch elements; a shunt measurement at the one or more semiconductor switch elements with the aid of a current-sensing resistor; a measurement with the aid of a magnetic-field-based current measurement, for example, using a Hall sensor or in another manner.

This results in a rapid and efficient recognition of a short-circuit or overcurrent situation, and thus a rapid switching-off of the charging-current path, which inhibits an adverse impact on the electrical and electronic components of the vehicle.

According to one form of the semiconductor-based fuse, the semiconductor-based fuse includes: a power section with the one or more semiconductor switch elements and the measurement sensor system, which is further configured to determine a switched-on resistance and/or a forward voltage of the one or more semiconductor switch elements; and a control section with the control system and a communications interface for a superordinate control device, in which the controlling of the communications interface is galvanically separated.

This results in that the power section can be disposed in the charging-current path of the battery-electric vehicle, where, in the case of a threshold current flow, it can interrupt the charging-current path. The control section does not lie in the charging-current path, and therefore components that correspond to the HV standards of the charging-current path can be omitted. Rather, merely components that function in the low voltage range may be used. The galvanic separation of the control system from the communications interface brings the advantage that a possible abnormal behavior of the control system has a reduced negative influence on the superordinate control device.

According to one form of the semiconductor-based fuse, the control system is configured to perform a diagnostic for the determining of a state of the one or more semiconductor-switch elements, in which the diagnostic is based on at least one of the following measurements on the one or more semiconductor-switch elements: measurement of a gate threshold voltage drift; measurement of a gate leakage current; and measurement of a supply voltage.

This results in that a state of the fuse can be shown to the superordinate control device at any point in time, so that when faults occur suitable countermeasures can be initiated.

According to one form of the semiconductor-based fuse, the control system is configured to switch on the one or more switched-off semiconductor-switch elements into the charging-current path of the battery-electric vehicle again, based on the diagnosis, in order to enable a renewed charging of the battery via the charging-current path.

This results in that the fuse is usable multiple times and may not be exchanged after a triggering. The service life of the fuse is thus increased, and a maintenance expense of the vehicle can be reduced.

According to one form of the semiconductor-based fuse, the semiconductor-base fuse includes a cooling system that is configured to cool the one or more semiconductor-switch elements using a coolant.

This results in that due to the cooling system, the semiconductor-switch elements become less hot and thus cannot be adversely impacted. Due to the cooling system, the fuse can also be operated with significantly higher short-circuit currents than without cooling and can switch them off.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a system circuit diagram of a charging system for the charging of a battery of a battery-electric vehicle according to one form of the present disclosure;

FIG. 2 shows a simplified block circuit diagram of a semiconductor-based fuse for a battery-electric vehicle according to one form of the present disclosure;

FIG. 3 shows a block circuit diagram of a semiconductor-based fuse according to one form of the present disclosure; and

FIG. 4 shows a cross-sectional view through a semiconductor-based fuse according to one form of the present disclosure.

The Figures are merely schematic representations and serve only for the explaining of the present disclosure. Identical or functionally identical elements are provided throughout with the same reference numbers.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, reference is made to the accompanying drawings that form a part thereof, and in which specific forms are shown as illustration, in which the present disclosure can be explained. It is understood that other forms can also be used, and structural or logical changes can also be undertaken, without deviating from the concept of the present disclosure. The following detailed description is therefore not to be understood in a limiting sense. Furthermore, it is understood that the features of the different exemplary forms described herein can be combined with one another if not specifically indicated otherwise.

The aspects and forms are described with reference to the drawings, in which identical reference numbers generally refer to identical elements. In the following description, for the purpose of explanation numerous specific details are presented in order to convey a detailed understanding of one or more aspects of the present disclosure. However, one or more aspects or forms can be embodied with a lesser degree of the specific details. It is understood that other forms can be used, and structural or logical changes can be undertaken, without deviating from the concept of the present disclosure.

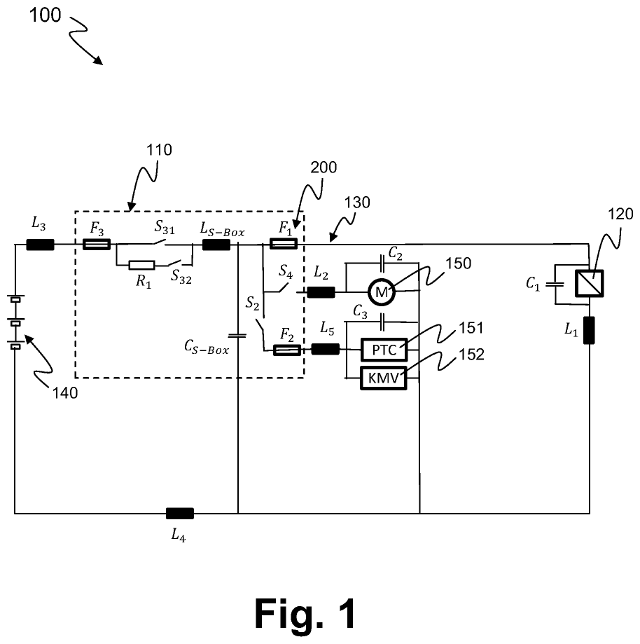

FIG. 1 shows a schematic circuit diagram of a charging system 100 for the charging of a battery of a battery-electric vehicle.

The charging system 100 comprises electrical and electronic components of the vehicle, shown on the left side, and electrical and electronic components of the charging infrastructure, shown on the right side. The charging infrastructure comprises a charging column 120 for the charging of the battery 140 of the vehicle, to which a capacitor C₁ is connected in parallel, and an inductance L₁ is connected in series.

On the vehicle side, the electrical and electronic components of the vehicle comprise a battery 140 for the powering of the vehicle, or an HV storage that is connected in series with the inductance L₃ at a first pole and an inductance L₄ at a second pole of the battery in the charging-current path 130.

An S-box 110 (switch-box or switchbox) is connected in the vehicle in the charging-current path 130, which S-box 110 enables a charging of the battery 140. The S-box 110 is also connected to a traction path as well as one or more auxiliary consumer paths. The S-box 110 controls the charging of the battery 140 and the operating of the traction path and the auxiliary consumer paths via the battery 140. Switches for switching-on on the charging infrastructure are not shown.

The traction path comprises an electric motor 150, to which a capacitor C₂ is connected in parallel, and an inductance L₂ is connected in series.

The auxiliary consumer paths comprise one or more electronic components connected in parallel, such as, for example, PTC 151 and KMV 152, to which a capacitor C₃ is connected in parallel and an inductance L₅ is connected in series.

The S-box 110 comprises a charging-infrastructure-side fuse F₁ 200, which can be a semiconductor-based fuse 200 as presented in this disclosure. The S-box 110 further comprises a battery-side fuse F₃, and inductance L_{S-box}, and a circuit with switches S₃₁ and S₃₂ connected in parallel, which are connected in series to the fuse F₁ 200 in the charging-current path 130. The battery-side fuse F₃ can also be embodied as a semiconductor-based fuse. A second circuit with switches S₄ and S₂ branches off between the fuse F₁ 200 and the inductance L_{S-box} in order to connect the traction path and the auxiliary consumer paths to the battery 140 when the vehicle is disconnected from the charging infrastructure. The auxiliary consumer paths are connected to the second circuit via a fuse F₂. The fuse F₂ can also be embodied as a semiconductor-based fuse, in which the fuse then does not serve to disconnect the charging path 130, but rather to disconnect the current path between battery 140 and auxiliary consumers 151, 152.

The S-box 110 further comprises a capacitor C_{S-box} that is connected in parallel with the charging infrastructure.

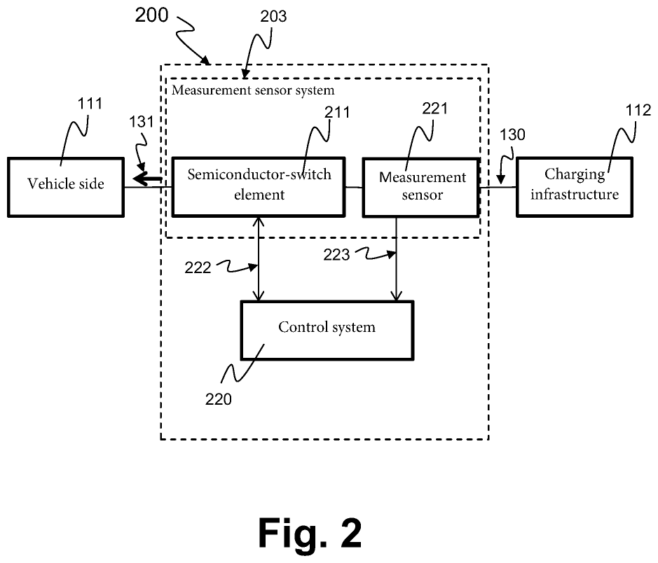

FIG. 2 shows a simplified block circuit diagram of a semiconductor-based fuse 200 for a battery-electric vehicle.

The semiconductor-based fuse 200 serves for the disconnecting of a charging-current path 130 for the charging of a battery 140 of a vehicle-side high voltage electrical system of a battery-electric vehicle, as depicted, for example, above in the charging system 100.

The semiconductor-based fuse 200 comprises one or more semiconductor-switch elements 211 that are switchable in a charging-current path 130 of the battery-electric vehicle in order to enable a charging of the battery 140 or of the HV storage 140 via the charging path 130.

The semiconductor-based fuse 200 comprises a measurement-sensor system 203 that is connectable in the charging-current path 130 of the battery-electric vehicle and is configured to detect a current 131 flowing through the one or more semiconductor-switch elements 211.

Although in FIG. 2 one semiconductor-switch element 211 is shown, more semiconductor-switch elements 211 can be present here, and in one form are connected with one another in parallel, which are connectable or connected in the charging-current path 130 between vehicle side 111 and charging infrastructure side 112.

The semiconductor-based fuse 200 comprises a control system 220 that is configured to switch off, upon reaching a threshold value of the detected current 131, the one or more semiconductor-switch elements 211 in order to disconnect the vehicle-side high voltage electrical system 111 from the charging-current path 130. The threshold value can be predetermined, for example, based on knowledge about the vehicle components and/or the charging infrastructure with which a possibly occurring short-circuit current or overcurrent is determinable.

The measurement sensor system 203 can comprise a measurement sensor 221 connected in series with the one or more semiconductor-switch elements 211, as shown in FIG. 2. In addition or alternatively, the measurement sensor system 203 can be configured to determine a current flowing over a threshold resistance of the one or more semiconductor-switch elements 211.

The measurement sensor system 203 can be configured to detect a current 131 in the charging direction, which current 131 flows from a charging infrastructure side 112 to the vehicle-side high voltage electrical system 111 of the battery-electric vehicle. The measurement sensor 221 can be configured to detect a current 131 against the charging direction, which current 131 flows from the vehicle-side high voltage electrical system 111 to the charging infrastructure side 112.

The control system 220 can be configured to switch off, upon the detection of a current 131 in the charging-current path 130 that flows against the charging direction and reaches the threshold value, the one or more semiconductor-switch elements 211. Various threshold values can be prescribed in the charging direction and against the charging direction, with which the semiconductor-based fuse 200 triggers. For example, opposite the charging direction a smaller threshold value can already be predetermined than in the charging direction, since with a current 131 flowing against the charging direction a short circuit can be assumed.

The control system 220 can be configured to switch off the one or more semiconductor-switch elements 211 unidirectionally upon the detection of a current 131, against the charging direction, exceeding the threshold value; or bidirectionally upon the detection of a current 131, in or against the charging direction, exceeding the threshold value.

In one form that is not shown in FIG. 2, the one or more semiconductor-switch elements 211 can comprise one or more pairs, connected in parallel, of semiconductor switches 211, in which each comprises two semiconductor switches 211 interconnected in series against each other. The pairs, connected in parallel, of semiconductor switches 211 are connectable or connected here in the charging-current path 130 between the vehicle side 111 and the charging infrastructure side 112. Alternatively, the one or more semiconductor switches 211 can be interconnected unidirectionally without being arranged in pairs.

The measurement sensor system 203 can be configured to detect the current 131 flowing through the one or more semiconductor-switch elements 211 based on at least one or a combination of the following measurements: a measurement or determination of a switched-on resistance of the one or more semiconductor-switch elements 211; a measurement or determination of a temperature of the one or more semiconductor-switch elements 211, a measurement or determination of a forward voltage of the one or more semiconductor-switch elements 211; a shunt measurement at the one or more semiconductor-switch elements 211 with the aid of a current-sensing resistor a measurement or determination with the aid of a magnetic-field-based current measurement, for example, using a Hall sensor or in another manner.

The Hall sensor delivers, for example, an output voltage that is proportional to the value of the vector product of the magnetic flux density and current of the one or more semiconductor switch elements 211. The Hall voltage is also temperature dependent and can be used to determine the current through the one or more semiconductor-switch elements 211.

The current-sensing resistor for the shunt measurement can be connected in parallel with the one or more semiconductor-switch elements 211 in order to derive an electrical current from this part. Alternatively, the current-sensing resistor can also be inserted in parallel in the charging-current path 130 and in series with the one or more semiconductor-switch elements 211. With a voltage-measurement device connected in parallel with the current-sensing resistor, the voltage drop at the current-sensing resistor, and thus the current through the one or more semiconductor switch elements 211, can be determined.

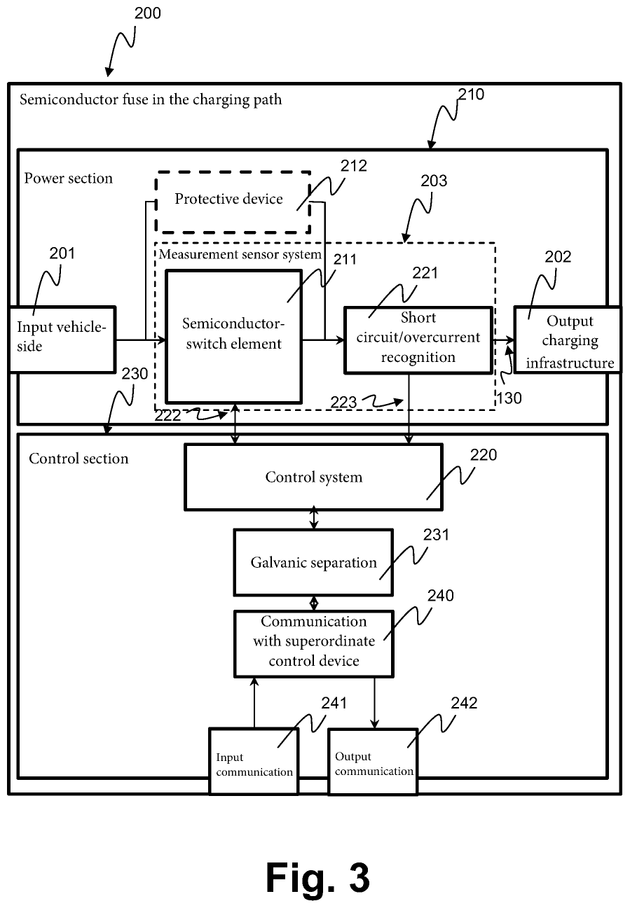

FIG. 3 shows a block diagram of a semiconductor-based fuse 200 according to one form.

The semiconductor-based fuse 200 shown in FIG. 3 corresponds to the semiconductor-based fuse 200 shown in FIG. 2, in which additional function blocks are shown in FIG. 3.

The semiconductor-based fuse 200, or, simplified, semiconductor fuse 200, is located in the DC path 130 in the vehicle, corresponding to the representation in FIG. 1. The semiconductor fuse 200 can be located in the HV-minus- or HV-plus-path of the DC charging path 130. The semiconductor fuse 200 can be combined with circuit breakers, or the semiconductor fuse 200 can also take over the switching of a circuit breaker and replace it.

As shown in FIG. 3, the semiconductor fuse 200 is comprised of a power section 210 and a control section 230. The power section 210 comprises the one or more semiconductor-switch elements 211 and the measurement sensor system 203. The measurement sensor system 203 can furthermore be configured to determine a switched-on voltage and/or a forward voltage of the one or more semiconductor-switch elements 211. The control section 230 comprises the control system 220 and a communications interface 240 to communicate with a superordinate control device that is galvanically separated from the communications interface 240 by a galvanic separation 231.

The semiconductor fuse 200 can be embodied uni-directional or bi-directional.

The semiconductor fuse 200 can be realized with IGBTs, Si-MOSFETs, SIC-MOSFETs, JFETs, GAN-MOSFETS, or other semiconductor components.

The semiconductor fuse 200 can be constructed from a single or multiple semiconductor-switch elements 211.

With the aid of a short-circuit detection, the semiconductor fuse 200 can independently recognize short circuits and disconnect them significantly more rapidly than a circuit breaker or a melting fuse (in the range of <100 μs).

Depending on the semiconductor-switch element 211, an additional protective device 212 can be provided for the one or the multiple semiconductor-switch elements 211. Here this protective device 212 can be connected in parallel with the one or the multiple semiconductor-switch elements 211, as shown in FIG. 3.

The semiconductor fuse 200 can reduce the stored energy in the line inductances, for example, the inductances L₁, L₃, L₄, L_{S-box} shown in FIG. 1, and also L₂ and L₅.

The semiconductor fuse 200 can be embodied such that it disconnects short-circuit currents from the battery 140, or disconnects short-circuit currents in both directions, i.e., battery 140 toward charging column 120, and charging column 120 toward battery 140, according to the depiction in FIG. 1.

The control system 220 can be configured to carry out a diagnostic for the determining of a state of the one or more semiconductor-switch elements 211. The diagnostic can be based on at least one of the following measurements on the one or more semiconductor-switch elements 211: measurement of a gate threshold voltage drift, measurement of a gate leakage current, measurement of a supply voltage.

The control system 220 can be configured to connect, based on the diagnostic, the one or more switched-off semiconductor-switch elements 211 into the charging-current path 130 of the battery-electric vehicle again in order to enable a renewed charging of the battery 140 via the charging-current path 130.

The semiconductor fuse 200 can also contain an overcurrent recognition for short-circuit detection.

As already mentioned above, the short-circuit detection and the overcurrent recognition can be affected with the aid of a shunt, Hall sensor, the measuring of the switched-on resistance, or the forward voltage of the semiconductor-switch element 211. In addition, the overcurrent recognition can be affected by a temperature measurement.

As shown in FIG. 3, the semiconductor fuse 200 contains, in addition to the power section 210, a control unit 230 or a control section 230, which comprises the control system 220. The control unit 230 or control system 220 switches the semiconductor-switch element 211 on/off, and evaluates the signals of the short-circuit recognition, overcurrent recognition, and temperature measurement.

Optionally, the control unit 230 has a diagnostic unit in order to check the state of the semiconductor fuse 200. The diagnostic unit implements diagnoses with respect to gate threshold voltage drift, gate leakage current, checking of the supply voltage, etc.

Inside the control unit 230, a galvanic separation 231 is used with the control system 220 for the communication interface 240 to communicate with the superordinate control device, for example, the battery management system to receive input communication 241 and to output communication 242.

As mentioned above, the control unit 230 or the control section 230 can communicate with a superordinate control device.

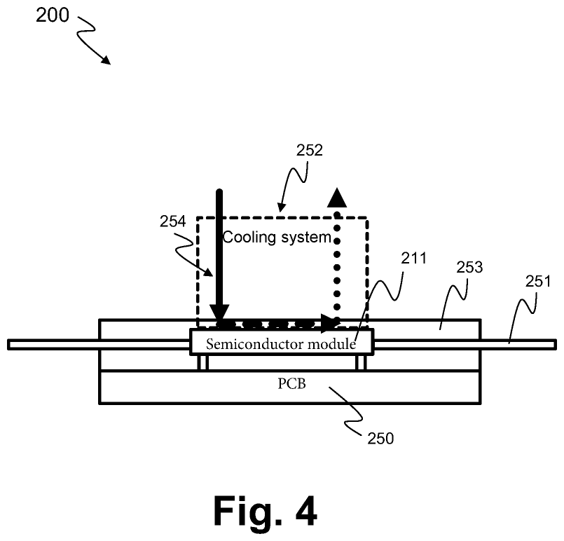

The semiconductor fuse 200 can be directly integrated in the water coolant circuit, as represented below for FIG. 4.

FIG. 4 shows a cross-sectional view through a semiconductor-based fuse 200 according to one form.

The semiconductor-based fuse 200 depicted in FIG. 4 corresponds to the semiconductor-base fuse 200 depicted in FIGS. 2 and 3, in which in FIG. 4 the physical construction is shown in more detail.

The semiconductor-based fuse 200 includes a cooling system 252 that is configured to cool one or more semiconductor-switch elements 211 using a coolant 254.

The semiconductor-based fuse 200 can be implemented on a circuit board (PCB, “printed circuit board) 250. The one or more semiconductor-switch elements 211 as described above can be implemented as a semiconductor module 211 that is placed on the circuit board 250 and is accommodated in a housing 253. The connection of the semiconductor module 211 from the housing 253 can be embodied by a lead-frame or busbar 251.

On the housing 253 the cooling system 252 can be implemented, which can supply the coolant 254 to the one or more semiconductor-switch elements 211, for example, the coolant 254 can be guided over a surface of the housing 253 in order to cool the one or more semiconductor-switch elements 211. The coolant 254 can be water or a common coolant for engine cooling, which extends, for example, over a first connection into a coolant channel over the one or more semiconductor-switch elements 211, and is guided away again out a second connection. Alternatively, the coolant 254 can be air that is guided over the housing 253 surface in order to cool the one or more semiconductor-switch elements 211.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A semiconductor-based fuse for a disconnecting of a charging-current path for a charging of a battery of a vehicle-side high voltage electrical system of a battery-electric vehicle, the semiconductor-based fuse comprising:
one or more semiconductor-switch elements that are switchable in a charging-current path of the battery-electric vehicle to enable a charging of the battery via the charging-current path;
a measurement sensor system that is configured to connect into the charging-current path of the battery-electric vehicle, and is configured to detect a current flowing through one or more semiconductor-switch elements; and
a control system that is configured to switch off the one or more semiconductor-switch elements upon reaching a threshold value of the detected current to disconnect the vehicle-side high voltage electrical system from the charging-current path.

2. The semiconductor-based fuse according to claim 1, wherein the measurement sensor system comprises a measurement sensor connected in series with the one or more semiconductor-switch elements.

3. The semiconductor-based fuse according to claim 2, wherein the measurement sensor system is configured to determine a current flowing over a threshold resistance of the one or more semiconductor-switch elements.

4. The semiconductor-based fuse according to claim 1, wherein the measurement sensor system is configured to determine a current flowing over a threshold resistance of the one or more semiconductor-switch elements.

5. The semiconductor-based fuse according to claim 1, wherein the measurement sensor system is configured to detect a current in a charging direction in which current flows from a charging infrastructure to the vehicle-side high voltage electrical system of the battery-electric vehicle, and the measurement sensor system is configured to detect a current against the charging direction in which current flows from the vehicle-side high voltage electrical system to the charging infrastructure.

6. The semiconductor-based fuse according to claim 5, wherein the control system is configured to switch off the one or more semiconductor-switch elements upon detection of the current in the charging-current path that flows against the charging direction and reaches the threshold value.

7. The semiconductor-based fuse according to claim 5, wherein the control system is configured to switch off the one or more semiconductor-switch elements unidirectionally upon detection of the current against the charging direction exceeding the threshold value.

8. The semiconductor-based fuse according to claim 5, wherein the control system is configured to switch off the one or more semiconductor-switch elements bidirectionally upon detection of the current in the charging direction or the current against the charging direction exceeding the threshold value.

9. The semiconductor-based fuse according to claim 1, wherein the one or more semiconductor-switch elements comprise one or more pairs of semiconductor switches connected in parallel, wherein each pair of semiconductor switches comprises two semiconductor switches interconnected against each other in parallel.

10. The semiconductor-based fuse according to claim 1, wherein the one or more semiconductor-switch elements are interconnected with one another unidirectionally.

11. The semiconductor-based fuse according to claim 1,
wherein the measurement sensor system is configured to detect the current flowing through the one or more semiconductor-switch elements based on at least one or a combination of:
a measurement of a switched-on resistance of the one or more semiconductor-switch elements;
a measurement of a temperature of the one or more semiconductor-switch elements;
a measurement of a forward voltage of the one or more semiconductor-switch elements;
a shunt measurement at the one or more semiconductor-switch elements with a current-sensing resistor; and
a measurement with a magnetic-field-based current measurement.

12. The semiconductor-based fuse according to claim 1, further comprising:
a power section including the one or more semiconductor-switch elements and the measurement sensor system, wherein the measurement sensor system is further configured to determine at least one of a switched-on resistance and a forward voltage of the one or more semiconductor-switch elements; and
a control section including the control system and a communications interface to a superordinate control device, and the control system is galvanically separated from the communications interface.

13. The semiconductor-based fuse according to claim 1, wherein the control system is configured to carry out a diagnostic for determining of a state of the one or more semiconductor-switch elements, and the diagnostic is based on one of:
a measurement of a gate threshold voltage drift of the one or more semiconductor-switch elements;
a measurement of a gate leakage current of the one or more semiconductor-switch elements; or
a measurement of a supply voltage of the one or more semiconductor-switch elements.

14. The semiconductor-based fuse according to claim 13, wherein the control system is configured to switch on one or more switched-off semiconductor-switch elements in the charging-current path of the battery-electric vehicle to enable a renewed charging of the battery via the charging-current path.

15. The semiconductor-based fuse according to claim 1, further comprising: a cooling system that is configured to cool the one or more semiconductor-switch elements using a coolant.
